(19) United States
(12) Patent Application Publication
(10) Pub. No.: US 2015/0030241 A1
(43) Pub. Date: Jan. 29, 2015

(54) METHOD AND SYSTEM FOR DATA IDENTIFICATION AND EXTRACTION USING PICTORIAL REPRESENTATIONS IN A SOURCE DOCUMENT

(71) Applicant: Intuit Inc., Mountain View, CA (US)

(72) Inventors: Samir Kakkar, Bangalore (IN); Anu Sreepathy, Bangalore (IN); Sunil Madhani, Mountain View, CA (US); Mithun U. Shenoy, Bangalore (IN)

(73) Assignee: Intuit Inc., Mountain View, CA (US)

(21) Appl. No.: 13/949,564

(22) Filed: Jul. 24, 2013

(51) Int. Cl. G06K 9/00

(52) U.S. Cl. CPC G06K 9/00469
USPC 382/165; 382/218

(57) ABSTRACT

Data extraction templates are created and associated with source documents from a specific source document source. One or more known pictorial representations associated with one or more source document sources are then identified and key data is generated for the known pictorial representations. Source document data is then obtained and analyzed to identify potential pictorial representation data. Key data associated with the potential pictorial representation data is then generated and compared with the key data associated with one or more known pictorial representations and if the key data matches, the data extraction template associated with the matched known pictorial representations is obtained and used for identifying and extracting data from the source document data.

### BACKGROUND

The widespread availability of optical image capture devices, such as cameras, implemented on, or with, computing systems, such as mobile devices and smart phones, has resulted in a significant number applications and systems that rely on the ability to identify and extract desired data from images of hard copy documents in order to obtain various types of information.

For instance, many currently available financial management systems, financial transaction management systems, tax-preparation systems, and various other data management systems, obtain data from optical images of source documents processed using Optical Character Recognition (OCR) systems, or similar data extraction technologies.

While the use of optical images and data extraction technology provides some capability to obtain information with minimal user input, there are several issues associated with these methods. One long-standing problem associated with using optical images and data extraction technology to obtain data is how to identify and extract desired data despite the fact that there is no standard format of source documents, such as bills, invoices, statements, etc., such that desired data, or a given data field, can be identified easily. For instance, a bill from one credit card provider may present the minimum payment due amount in the lower right corner of the source document, i.e. the bill, while a bill from a second credit card provider may present the minimum payment due amount in the middle left of the document.

This situation creates a significant disadvantage and complication for the use of optical images and data extraction technology.

### SUMMARY

In accordance with one embodiment, a system and method for data identification and extraction using pictorial representations in a source document includes creating and/or obtaining one or more data extraction templates for identifying and extracting data from one or more source documents. In one embodiment, each data extraction template is associated with source documents from a specific source document source and the data representing the one or more data extraction templates is stored in a template database.

In one embodiment, one or more known pictorial representations are identified that are associated with one or more source document sources. In one embodiment, key data associated with each of the one or more known pictorial representations is generated and the key data associated with the one or more known pictorial representations is stored. In one embodiment, the key data associated with the one or more known pictorial representations is correlated with its associated source document source and the data extraction template for source documents from that source document source.

In one embodiment, source document data is obtained from which it is desired to identify and extract source data. In one embodiment, the source document data is analyzed to identify potential pictorial representation data. In one embodiment, the potential pictorial representation data obtained from the source document data is then analyzed and key data associated with the potential pictorial representation data obtained from the source document data is generated.

In one embodiment, the key data associated with the potential pictorial representation data obtained from the source document data is compared with the key data associated with the one or more known pictorial representations. In one embodiment, if the key data associated with the potential pictorial representation data from the source document data matches the key data associated with a matched one of the known pictorial representations, the data extraction template associated with the matched one of the known pictorial representations is obtained and used for identifying and extracting data from the source document data.

### BRIEF DESCRIPTION OF THE DRAWINGS

FIG. 1 is a block diagram of an exemplary hardware architecture for implementing one embodiment;

FIG. 2 is a flow chart depicting a process for data identification and extraction using pictorial representations in a source document in accordance with one embodiment;

FIG. 3A shows one illustrative example of source document data obtained in accordance with one embodiment;

FIG. 3B shows the source document data of FIG. 3A after OCR processing is performed to generate OCR processed blocks in accordance with one embodiment;

FIG. 3C shows a pictorial representation region extracted from the source document data of FIG. 3B in accordance with one embodiment;

FIG. 3D shows the extracted pictorial representation region of FIG. 3C after chroma key filtering is applied to remove any background noise and the extracted pictorial representation region is converted to a gray-scale image in accordance with one embodiment; and

FIG. 3E shows key data generated and associated with the gray-scale image of FIG. 3D in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

Herein, the terms “source document” includes, but is not limited to, any printed representation, or electronic data representation, or optical image data representation, of a document from which it is desired to extract source document data. Specific illustrative examples of source documents include, but are not limited to, invoices, bills, statements, warranties, contracts, or any other documents, or representations of documents, as discussed herein, and/or as known in the art at the time of filing, and/or as developed after the time of filing.

Herein, the term “source data” and “source document data” are used interchangeably and include data representing characters, symbols, text, visual images, and any other information or data obtained from a source document, or an image of a source document, as discussed herein, and/or as known in the art at the time of filing, and/or as developed after the time of filing.

Herein the term “pictorial representation” includes any representation, symbol, character, or image associated with a source document source that identifies the source document source, and/or source documents from that source document source. Illustrative examples of “pictorial representations” include, but are not limited to, logos, graphics, trademarks, or other symbols associated with companies, individuals, corporations, or any other entities as discussed herein, and/or as known in the art at the time of filing, and/or as developed after the time of filing.

Herein the term “potential pictorial representation” includes any portion of a source document identified as a non-textual portion of the source document that may contain a representation, symbol, character, or image associated with a source document source that identifies the source document source, and/or source documents from that source document source, as discussed herein, and/or as known in the art at the time of filing, and/or as developed after the time of filing.

In one embodiment, a process for data identification and extraction using pictorial representations in a source document includes one or more applications, such as software packages, modules, or systems, implemented on one or more computing systems.

In one embodiment, one or more of the computing systems is/are a mobile computing system such as a smart phone, or other mobile device, including an integrated camera function. However, as used herein, the term “computing system”, includes, but is not limited to, a desktop computing system; a portable computing system; a mobile computing system; a laptop computing system; a notebook computing system; a tablet computing system; a workstation; a server computing system; a mobile phone; a smart phone; a wireless telephone; a two-way pager; a Personal Digital Assistant (PDA); a media player, i.e., an MP3 player and/or other music and/or video player; an Internet appliance; or any device that includes components that can execute all, or part, of any one of the processes and/or operations as described herein. In addition, as used herein, the term computing system, can denote, but is not limited to, systems made up of multiple desktop computing systems; portable computing systems; mobile computing systems; laptop computing systems; notebook computing systems; tablet computing systems; workstations; server computing systems; smart phones; wireless telephones; two-way pagers; Personal Digital Assistants (PDAs); media players; Internet appliances; or any devices that can be used to perform the processes and/or operations as described herein.

In one embodiment, one or more computing systems are connected by one or more communications channels, such as, but not limited to: any general network, communications network, or general network/communications network system; a cellular network; a wireless network; a combination of different network types; a public network; a private network; a satellite network; a POTS network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, a POTS network; any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

In one embodiment, one or more data extraction templates for identifying and extracting data from one or more source documents are created.

As noted above, a long-standing problem associated with using optical images and data extraction technology to obtain desired data is how to identify and extract desired data despite the fact that there is no standard format for source documents, such as bills, invoices, statements, etc., such that desired data, or a given data field, can be identified easily.

For instance, a bill from one credit card provider may present the minimum payment due amount in the lower right corner of the source document, i.e. the bill, while a bill from a second credit card provider may present the minimum payment due amount in the middle left of the document. Consequently, when data representing the minimum payment due amount is needed for extraction, it is not clear where to find the desired data in the source document, i.e., the bill.

In one embodiment, a data extraction template including data identifying/mapping the location of desired/specific data in source documents from a specific source document source is created for one or more source document sources. In various embodiments, the data extraction templates are used to identify and extract desired data from a source document once the source of the source document is identified.

In various embodiments, the data extraction templates for multiple source document sources are generated and stored in a template database. As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to an on-line function. Herein, the term “database” can refer to any data storage means that is part of, or under the control of, any computing system, as discussed herein, known at the time of filing, or as developed thereafter.

As a specific illustrative example, assume that bills from a first source document source, in this specific example a credit card provider named “source alpha”, presents the minimum payment due amount in the lower right corner of the bill. In this specific illustrative example, a data extraction template for the source document source, i.e., source alpha, is generated that indicates that the minimum payment due amount on a bill from source alpha is obtained from the lower right corner of the bill.

Likewise, as a specific illustrative example, assume that statements from a second source document source, in this specific example a bank named “source bravo”, presents the minimum payment due amount in the upper left corner of the statement. In this specific illustrative example, a data extraction template for the source document source, i.e., source bravo, is generated that indicates that the minimum payment due amount on a statement from source bravo is obtained from the upper left corner of the document.

In this specific illustrative example, data representing the data extraction template for source alpha is associated with source alpha and data representing the data extraction template for source bravo is associated with source bravo and the correlated data representing the two data extraction templates is stored in a template database.

In one embodiment, one or more known pictorial representations are identified that are associated with source document sources. As noted above, herein the term “pictorial representation” includes any representation, symbol, character, or image associated with a source document source that identifies that source document source, and/or source documents from that source document source. Illustrative examples of “pictorial representations” include, but are not limited to, logos, graphics, trademarks, or other symbols associated with companies, individuals, corporations, or any other entities as discussed herein, and/or as known in the art at the time of filing, and/or as developed after the time of filing.

In one embodiment, data representing the known pictorial representations is analyzed and key data associated with the one or more known pictorial representations is generated. In one embodiment, key data associated with the one or more known pictorial representations is generated using a standard hashing library that creates a hash associated with each of the one or more known pictorial representations.

In one embodiment, the key data associated with the one or more known pictorial representations is then correlated to the respective source document sources, and data extraction templates, in the template database with the result that, in one embodiment, data extraction templates are correlated and mapped to key data associated with the one or more known pictorial representations in the template database, i.e., the data extraction templates are associated with the key data identifying the source document source.

Continuing with the specific illustrative example introduced above, assume source alpha bills include a known pictorial representation associated with source alpha that is a source alpha logo including a graphic representation of a capital letter “A” superimposed on an American flag. Further assume the source bravo statements include a known pictorial representation associated with source bravo that is a source bravo trademark including a graphic representation of the source bravo bank building.

In this specific illustrative example, the source alpha logo would be analyzed and assigned a unique hash for the graphic representation of a capital letter “A” superimposed on an American flag and the source bravo trademark would be analyzed and assigned a unique hash for the graphic representation of the source bravo bank building. This key data for the source alpha logo would then be correlated with source alpha and mapped to the source alpha data extraction template in the template database. Likewise, the key data for the source bravo trademark would be correlated with source bravo and mapped to the source bravo data extraction template in the template database.

In one embodiment, source document data is obtained. In one embodiment, the source of the source document data, i.e., the entity generating the source document, is initially unknown by the system and method for data identification and extraction using pictorial representations in a source document. In one embodiment, the source document data is obtained using an image capture device, such as a camera associated with a computing system. In various embodiments, the source document can be any hard copy, or printed, document such as, but not limited to, a bill, an invoice, a bank statement, a credit card statement, a document associated with a financial transaction, a tax document, a warranty document, or any other hard copy or printed document, as discussed herein, and/or as known in the art at the time of filing, and/or as developed after the time of filing. In one embodiment, the source document data is obtained as electronic data via, as illustrative examples, e-mail or the Internet.

In one embodiment, it is desired to identify the source of the source document data and then identify and extract specific source data from the source document data. In one embodiment, the source document data is analyzed to identify potential pictorial representations within the source document data.

As discussed above, herein the term “potential pictorial representation” includes any portion of a source document identified as a portion of the source document that may contain a representation, symbol, character, or image associated with a source document source that identifies that source document source, and/or source documents from that source document source. Illustrative examples of “pictorial representations” include, but are not limited to, logos, graphics, trademarks, or other symbols associated with companies, individuals, corporations, or any other entities as discussed herein, and/or as known in the art at the time of filing, and/or as developed after the time of filing.

In one embodiment, the source document data is analyzed to identify potential pictorial representations by first identifying non-text data and any identified non-text data is designated as potential pictorial representation data. In one embodiment, the potential pictorial representation data is then analyzed and key data associated with the potential pictorial representation data is generated. In various embodiments, the text data for any given locale or language can be identified.

In one embodiment, potential pictorial representations are identified by first obtaining source document data in the form of digital image data representing the source document, e.g., a digital image of the source document. In various embodiments, the digital image data representation of the source document is obtained using a digital image capture capability associated with a computing system, such as a camera capability included with a smart phone accessible by the user.

In this embodiment, digital image data representing the source document is sent to an Optical Character Recognition (OCR) capability, such as any OCR engine, for text extraction. In one embodiment, the OCR capability returns a collection of text data along with the associated location within the source document.

In one embodiment, the entire digital image of the source document is scanned, in one embodiment, starting from the top left of the document, to detect the luminosity of each pixel by scanning through the digital image data representing the source document row by row. In one embodiment, all regions determined by the OCR engine to contain textual data are avoided.

In one embodiment, luminosity for each pixel is obtained by applying weights to Red (R), Green (G) and Blue (B) channels to generate greyscale pixels. In one embodiment, the greyscale strength so determined is designated the luminosity of the pixel. In one embodiment, when a threshold change in luminosity is encountered when scanning from one pixel to the adjacent pixel, or nearby pixels, this change is determined to indicate the start of a potential pictorial representation, i.e., a graphic or logo in the digital image of the source document. In one embodiment, this location is marked and scanning continues until a second luminosity change above the threshold value is detected. Once a second threshold change in luminosity is detected, this change is determined to indicate the end of the potential pictorial representation. This process is then repeated to detect the entire potential pictorial representation region, e.g., bounding box rectangle, or other shape, of the potential pictorial representation.

The identified potential pictorial representation region is then extracted from the digital image of the source document and the data is sent to the same hashing process used to create the hash associated with each of the one or more known pictorial representations in the template database. The hash value for the potential pictorial representation is then designated as the key data associated with the potential pictorial representation.

In one embodiment, the key data associated with the potential pictorial representation is then analyzed and compared with the key data associated with the known pictorial representations in the template database for known source documents sources, i.e., organizations, corporations, persons, parties, or other entities associated with the known pictorial representation.

In one embodiment, if the key data associated with the potential pictorial representation is determined to match the key data associated with one of the known pictorial representations in the template database, then the data extraction template for the associated source document source is obtained and used to identify and extract the desired source data from the source document data.

As a specific illustrative example, assume a user takes a picture of a paper bill including the bill payee's logo using mobile computing system camera.

The digital image of the paper bill is then scanned to detect the logo/letterhead associated with the provider of the bill. The logo/letterhead data is then processed as discussed above to generate key data for the logo/letterhead.

In this specific illustrative example, the key data associated with the logo/letterhead is then matched against key data representing known pictorial representations in the template database to identify the correct data extraction template to be used on the current source document data. The correct data extraction template can then be used to accurately extract relevant information/data, such as, but not limited to, payee name, address, account number, due date, amount due, etc.

As another specific illustrative example, assume a user opens a paper bill from a small business. The user intends to perform an electronic bill payment. The user then captures an image of the bill using an image capture device associated with the user's cell phone.

OCR technology is then used to scan the entire image of the bill and any the portion of the image of the bill that is detected to contain non-text data is designated a potential pictorial representation area. These potential pictorial representation areas are then cropped and resized. A hash value or unique signature is calculated for the potential pictorial representation areas, which is used as key data for the potential pictorial representation areas. The key data for a potential pictorial representation area is then analyzed and compared with key data associated with known pictorial representations in the template database.

If a match is found, relevant information in the source document, i.e., the bill, such as payee name, address, account number is extracted using the data extraction template associated with the matched pictorial representations in the template database.

The extracted data is then presented to the user for review. If the extracted information/data is correct, the user can accept the extracted data and complete bill payment.

In one embodiment, if no match is found, the user is presented with an option to create a data extraction template and this data extraction template, along with the key data associated with potential pictorial representations in the bill, is added to the known pictorial representations data in the template database for future users.

Using the method and system for data identification and extraction using pictorial representations in a source document discussed herein, pictorial representations, such as logos, present in a source document are used to identify the organization, corporation, person, party, or other entity associated with the pictorial representation, i.e., the source of the source document, and to obtain the correct data extraction template associated with that source document. In this way, data can be extracted from various source documents despite the fact that various source documents from different sources and will include different formatting and different placement of data fields and data.

Consequently, using the method and system for data identification and extraction using pictorial representations in a source document, the extraction and transfer of data from source documents to various data management systems is made more efficient, accurate, and user-friendly.

### Hardware System Architecture

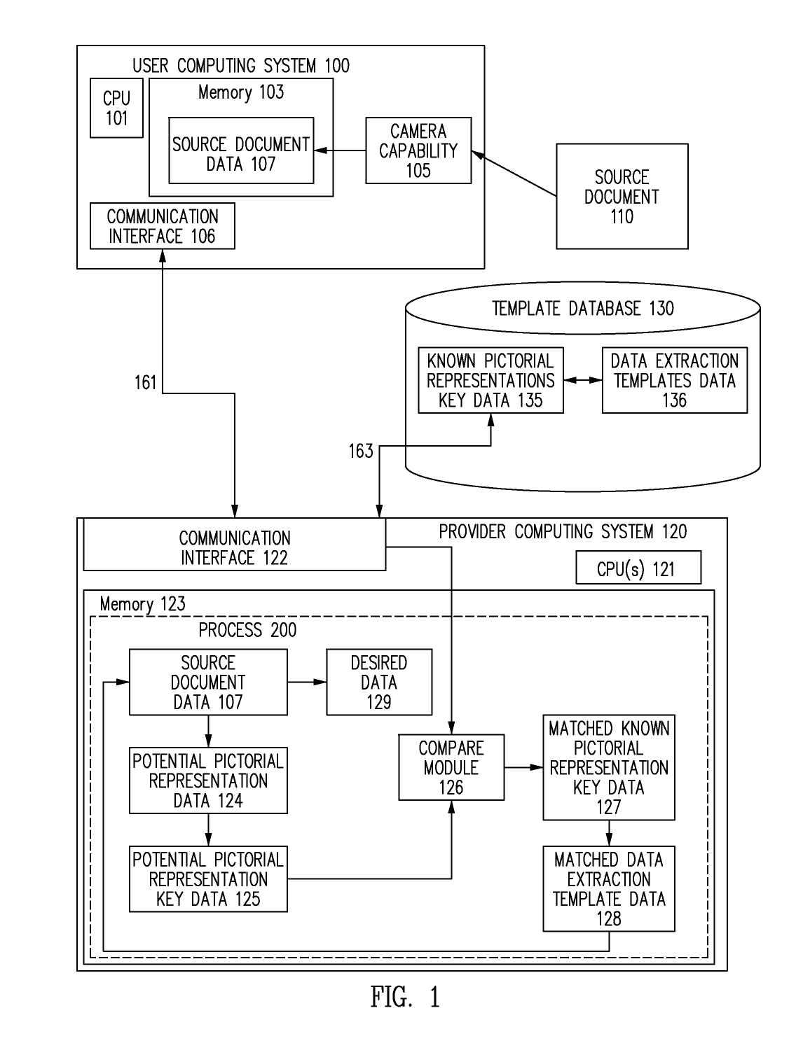

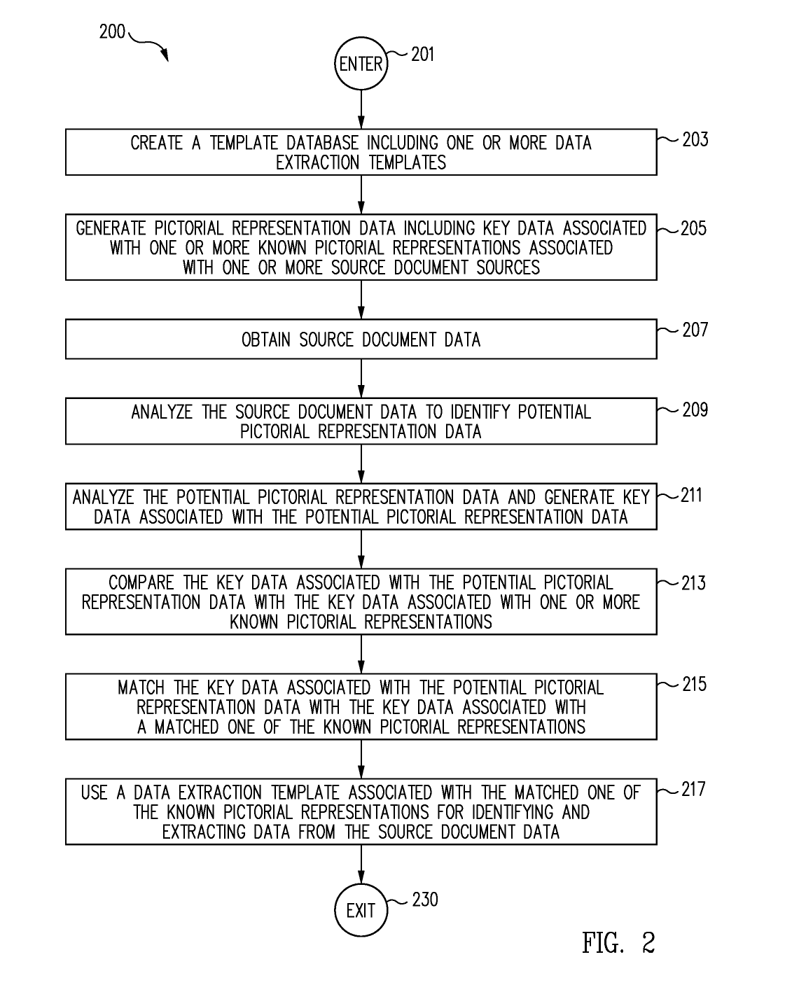

FIG. 1 is a block diagram of an exemplary hardware architecture for implementing one embodiment of a process for data identification and extraction using pictorial representations in a source document, such as exemplary process 200 (FIG. 2) discussed herein.

Shown in FIG. 1 is a source document 110 provided by a source document source, e.g. any source document from which it is desired to identify and extract desired data; a user computing system 100, e.g., a mobile computing system with a camera, or other optical image capture, capability accessible by a user of a process for data identification and extraction using pictorial representations in a source document, such as exemplary process 200 (FIG. 2) discussed herein; a provider computing system 120, e.g., a server or backend computing system implementing, in one embodiment, at least part of a process for data identification and extraction using pictorial representations in a source document, such as exemplary process 200 (FIG. 2) discussed herein; a template database 130, e.g., any data store maintaining data extraction templates mapped to known pictorial representations key data as discussed herein; all operatively coupled by communications channels 161 and 163.

In one embodiment, one or more data extraction templates for identifying and extracting data from one or more source documents are created and stored as data extraction templates data 136.

In one embodiment, data extraction templates data 136 includes data identifying/mapping the location of desired/specific data in source documents, such as source document 110, from a specific source document source with each data extraction template being created for one or more source document sources. In various embodiments, the data extraction templates represented by data extraction templates data 136 are used to identify and extract desired data 129 from a source document, such as source document 110, once the source of the source document is identified.

In various embodiments, data extraction templates data 136 for multiple source document sources are generated and then stored in template database 130. As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to an on-line function. Herein, the term “database” can refer to any data storage means that is part of, or under the control of, any computing system, as discussed herein, known at the time of filing, or as developed thereafter.

In one embodiment, one or more known pictorial representations are identified that are associated with source document sources. As noted above, herein the term “pictorial representation” includes any representation, symbol, character, or image associated with a source document source that identifies that source document source, and/or source documents from that source document source. Illustrative examples of “pictorial representations” include, but are not limited to, logos, graphics, trademarks, or other symbols associated with companies, individuals, corporations, or any other entities as discussed herein, and/or as known in the art at the time of filing, and/or as developed after the time of filing.

In one embodiment, data representing the known pictorial representations is analyzed and key data associated with the one or more known pictorial representations, shown as known pictorial representations key data 135 in FIG. 1, is generated. In one embodiment, known pictorial representations key data 135 is generated using a standard hashing library (not shown) that creates a hash associated with each of the one or more known pictorial representations.

In one embodiment, the known pictorial representations key data 135 is then correlated to the respective source document sources and data extraction templates represented by data extraction templates data 136 in template database 130 with the result that, in one embodiment, the specific data extraction templates of data extraction templates data 136 are correlated and mapped to known pictorial representations key data 135 for the one or more known pictorial representations in template database 130, i.e., the data extraction templates of data extraction templates data 136 are associated with the key data of known pictorial representations key data 135 identifying the source document sources.

In one embodiment, source document data 107 is obtained from source document 110 using camera capability 105 of user computing system 100.

As noted above, in one embodiment, source document 110 is any printed representation, or electronic data representation, or optical image data representation, of a document from which it is desired to extract desired data 129. Specific illustrative examples of source documents 110 include, but are not limited to, invoices, bills, statements, warranties, contracts, or any other documents, or representations of documents, as discussed herein, and/or as known in the art at the time of filing, and/or as developed after the time of filing.

In one embodiment, the source of the source document 110, i.e., the entity generating source document 110 is initially unknown. In one embodiment, it is desired to identify the source of the source document 110 and then identify and extract specific desired data 129.

In one embodiment, user computing system 100 includes CPU 101, memory 103, camera capability 105, and communications interface 106.

In one embodiment, user computing system 100 is a mobile computing system such as a smart phone, or other mobile device, including an integrated camera function, e.g., camera capability 105. However, user computing system 100 can be any computing system as discussed herein, and/or as known in the art at the time of filing, and/or as developed thereafter, that includes components that can execute all, or part, of a process for data identification and extraction using pictorial representations in a source document in accordance with at least one of the embodiments as described herein.

In one embodiment, source document data 107 is forwarded to provider computing system 120 via communications interface 106, communications channel 161, and communications interface 122.

In one embodiment, at provider computing system 120 source document data 107 is analyzed under the direction of CPU(s) 121 to identify potential pictorial representation data 124 by first identifying non-text data and any identified non-text data is designated as potential pictorial representation data 124.

In one embodiment, potential pictorial representation data 124 is then analyzed and potential pictorial representation key data 125 associated with potential pictorial representation data 124 is generated.

In one embodiment, potential pictorial representation data 124 is identified by first obtaining source document data 107 in the form of digital image data (not shown) representing source document 110, e.g., a digital image of source document 110.

In this embodiment, digital image data representing source document 110 is sent to an Optical Character Recognition (OCR) capability (not shown), such as any OCR engine, for text extraction. In one embodiment, the OCR capability returns a collection of text data (not shown) along with the associated location within source document 110.

In one embodiment, the entire digital image of source document 110 is scanned, in one embodiment, starting from the top left of the document, to detect the luminosity of each pixel by scanning through the digital image data representing source document 110 row by row. In one embodiment, all regions determined by the OCR engine to contain textual data are avoided.

In one embodiment, luminosity for each pixel is obtained by applying weights to Red (R), Green (G) and Blue (B) channels to generate greyscale pixels. In one embodiment, the greyscale strength so determined is designated the luminosity of the pixel. In one embodiment, when a threshold change in luminosity is encountered when scanning from one pixel to the adjacent pixel, this change is determined to indicate the start of a potential pictorial representation, i.e., a graphic or logo in the digital image of the source document. In one embodiment, this location is marked and scanning continues until the luminosity changes again above the threshold value. Once this change back is detected, this change is determined to indicate the end of the potential pictorial representation. This process is then repeated to detect the entire potential pictorial representation region, e.g., bounding box rectangle, or other shape of the potential pictorial representation.

The identified potential pictorial representation region is then extracted from the digital image of the source document and stored as potential pictorial representation data 124. In one embodiment, potential pictorial representation data 124 is then sent to the same hashing process (not shown) used to create the hash associated with each of the one or more known pictorial representations, i.e., used to generate known pictorial representations key data 135 in template database 130. The hash value for potential pictorial representation data 124 is then designated as potential pictorial representation data key data 125 associated with the potential pictorial representation.

In one embodiment, using compare module 126, potential pictorial representation data key data 125 is analyzed and compared with known pictorial representations key data 135 in template database 130 using communications interface 122 and communications channel 163.

In one embodiment, as a result of the analysis performed at compare module 126, matched known pictorial representations key data 127 is identified that matches potential pictorial representation data key data 125. Matched data extraction template data 128 associated with matched known pictorial representations key data 127 is then identified and obtained. The data extraction template represented by matched data extraction template data 128 is then used to process source document data 107 and to identify and extract desired data 129.

### Process

In accordance with one embodiment, a process for data identification and extraction using pictorial representations in a source document includes creating and/or obtaining one or more data extraction templates for identifying and extracting data from one or more source documents. In one embodiment, each data extraction template is associated with source documents from a specific source document source and the data representing the one or more data extraction templates is stored in a template database.

In one embodiment, one or more known pictorial representations are identified that are associated with one or more source document sources. In one embodiment, key data associated with each of the one or more known pictorial representations is generated and the key data associated with the one or more known pictorial representations is stored. In one embodiment, the key data associated with the one or more known pictorial representations is correlated with its associated source document source and the data extraction template for source documents from that source document source.

In one embodiment, source document data is obtained from which it is desired to identify and extract source data. In one embodiment, the source document data is analyzed to identify potential pictorial representation data. In one embodiment, the potential pictorial representation data obtained from the source document data is then analyzed and key data associated with the potential pictorial representation data obtained from the source document data is generated.

In one embodiment, the key data associated with the potential pictorial representation data obtained from the source document data is compared with the key data associated with the one or more known pictorial representations. In one embodiment, if the key data associated with the potential pictorial representation data from the source document data matches the key data associated with a matched one of the known pictorial representations, the data extraction template associated with the matched one of the known pictorial representations is obtained and used for identifying and extracting data from the source document data.

Process 200 for data identification and extraction using pictorial representations in a source document begins at ENTER OPERATION 201 of FIG. 2 and process flow proceeds to CREATE A TEMPLATE DATABASE INCLUDING ONE OR MORE DATA EXTRACTION TEMPLATES OPERATION 203.

In one embodiment, at CREATE A TEMPLATE DATABASE INCLUDING ONE OR MORE DATA EXTRACTION TEMPLATES OPERATION 203 one or more data extraction templates for identifying and extracting data from one or more source documents are created.

As noted above, a long-standing problem associated with using optical images and data extraction technology to obtain desired data is how to identify and extract desired data despite the fact that there is no standard format for source documents, such as bills, invoices, statements, etc., such that desired data, or a given data field, can be identified easily.

For instance, a bill from one credit card provider may present the minimum payment due amount in the lower right corner of the source document, i.e. the bill, while a bill from a second credit card provider may present the minimum payment due amount in the middle left of the document. Consequently, when data representing the minimum payment due amount is needed for extraction, it is not clear where to find the desired data in the source document, i.e., the bill.

In one embodiment, at CREATE A TEMPLATE DATABASE INCLUDING ONE OR MORE DATA EXTRACTION TEMPLATES OPERATION 203 a data extraction template including data identifying/mapping the location of desired/specific data in source documents from a specific source document source is created for one or more source document sources.

In various embodiments, the data extraction templates of CREATE A TEMPLATE DATABASE INCLUDING ONE OR MORE DATA EXTRACTION TEMPLATES OPERATION 203 are used to identify and extract desired data from a source document once the source of the source document is identified.

In various embodiments, at CREATE A TEMPLATE DATABASE INCLUDING ONE OR MORE DATA EXTRACTION TEMPLATES OPERATION 203 the data extraction templates for multiple source document sources are generated and then stored in a template database.

As used herein, the term “database” includes, but is not limited to, any data storage mechanism known at the time of filing, or as developed thereafter, such as, but not limited to, a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to an on-line function. Herein, the term “database” can refer to any data storage means that is part of, or under the control of, any computing system, as discussed herein, known at the time of filing, or as developed thereafter.

As a specific illustrative example, assume that bills from a first source document source, in this specific example a credit card provider named “source alpha”, presents the minimum payment due amount in the lower right corner of the bill.

In this specific illustrative example, at CREATE A TEMPLATE DATABASE INCLUDING ONE OR MORE DATA EXTRACTION TEMPLATES OPERATION 203 a data extraction template for the source document source, i.e., source alpha, is generated that indicates that the minimum payment due amount on a bill from source alpha is obtained from the lower right corner of the bill.

Likewise, as a specific illustrative example, assume that statements from a second source document source, in this specific example a bank named “source bravo”, presents the minimum payment due amount in the upper left corner of the statement.

In this specific illustrative example, at CREATE A TEMPLATE DATABASE INCLUDING ONE OR MORE DATA EXTRACTION TEMPLATES OPERATION 203 a data extraction template for the source document source, i.e., source bravo, is generated that indicates that the minimum payment due amount on a statement from source bravo is obtained from the upper left corner of the document.

In this specific illustrative example, at CREATE A TEMPLATE DATABASE INCLUDING ONE OR MORE DATA EXTRACTION TEMPLATES OPERATION 203 data representing the data extraction template for source alpha is associated with source alpha and data representing the data extraction template for source bravo is associated with source bravo and the correlated data representing the two data extraction templates is stored in a template database.

In one embodiment, once one or more data extraction templates for identifying and extracting data from one or more source documents are created at CREATE A TEMPLATE DATABASE INCLUDING ONE OR MORE DATA EXTRACTION TEMPLATES OPERATION 203, process flow proceeds to GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205.

In one embodiment, at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 one or more known pictorial representations are identified that are associated with source document sources and key data associated with the one or more known pictorial representations is generated.

As noted above, herein the term “pictorial representation” includes any representation, symbol, character, or image associated with a source document source that identifies that source document source, and/or source documents from that source document source. Illustrative examples of “pictorial representations” include, but are not limited to, logos, graphics, trademarks, or other symbols associated with companies, individuals, corporations, or any other entities as discussed herein, and/or as known in the art at the time of filing, and/or as developed after the time of filing.

In one embodiment, at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 data representing the known pictorial representations is analyzed and key data associated with the one or more known pictorial representations is generated.

In one embodiment, at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 key data associated with the one or more known pictorial representations is generated using a standard hashing library that creates a hash associated with each of the one or more known pictorial representations.

In one embodiment, at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 the key data associated with the one or more known pictorial representations is then correlated to the respective source document sources and data extraction templates in the template database of CREATE A TEMPLATE DATABASE INCLUDING ONE OR MORE DATA EXTRACTION TEMPLATES OPERATION 203 with the result that, in one embodiment, data extraction templates are correlated and mapped to key data associated with the one or more known pictorial representations in the template database, i.e., the data extraction templates of CREATE A TEMPLATE DATABASE INCLUDING ONE OR MORE DATA EXTRACTION TEMPLATES OPERATION 203 are associated with the key data identifying the source document source.

Continuing with the specific illustrative example introduced above, assume source alpha bills include a pictorial representation associated with source alpha that is a source alpha logo including a graphic representation of a capital letter “A” superimposed on an American flag. Further assume the source bravo statements include a pictorial representation associated with source bravo that is a source bravo trademark including a graphic representation of the source bravo bank building.

In this specific illustrative example, at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 the source alpha logo would be analyzed and assigned a unique hash for the graphic representation of a capital letter “A” superimposed on an American flag and the source bravo trademark would be analyzed and assigned a unique hash for the graphic representation of the source bravo bank building. This key data for the source alpha logo would then be correlated with source alpha and mapped to the source alpha data extraction template in the template database.

Likewise, at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 the key data for the source bravo trademark would be correlated with source bravo and mapped to the source bravo data extraction template in the template database.

In one embodiment, once one or more known pictorial representations are identified that are associated with source document sources and key data associated with the one or more known pictorial representations is generated at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205, process flow proceeds to OBTAIN SOURCE DOCUMENT DATA OPERATION 207.

In one embodiment, at OBTAIN SOURCE DOCUMENT DATA OPERATION 207, source document data is obtained.

In one embodiment, the source of the source document data, i.e., the entity generating the source document, obtained at OBTAIN SOURCE DOCUMENT DATA OPERATION 207 is initially unknown.

In one embodiment, the source document data is obtained at OBTAIN SOURCE DOCUMENT DATA OPERATION 207 using an image capture device, such as a camera associated with a computing system.

In various embodiments, the source document of OBTAIN SOURCE DOCUMENT DATA OPERATION 207 can be any hard copy, or printed, document such as, but not limited to, a bill, an invoice, a bank statement, a credit card statement, a document associated with a financial transaction, a tax document, a warranty document, or any other hard copy or printed document, as discussed herein, and/or as known in the art at the time of filing, and/or as developed after the time of filing. In one embodiment, the source document data is obtained as electronic data via, as illustrative examples, e-mail or the Internet.

In one embodiment, it is desired to identify the source of the source document data of OBTAIN SOURCE DOCUMENT DATA OPERATION 207 and then identify and extract specific desired source data from the source document data.

In one embodiment, once source document data is obtained at OBTAIN SOURCE DOCUMENT DATA OPERATION 207, process flow proceeds to ANALYZE THE SOURCE DOCUMENT DATA TO IDENTIFY POTENTIAL PICTORIAL REPRESENTATION DATA OPERATION 209.

In one embodiment, at ANALYZE THE SOURCE DOCUMENT DATA TO IDENTIFY POTENTIAL PICTORIAL REPRESENTATION DATA OPERATION 209 the source document data of OBTAIN SOURCE DOCUMENT DATA OPERATION 207 is analyzed to identify potential pictorial representations within the source document data.

As discussed above, herein the term “potential pictorial representation” includes any portion of a source document identified as a non-textual portion of the source document that may contain a representation, symbol, character, or image associated with a source document source that identifies that source document source, and/or source documents from that source document source. Illustrative examples of “pictorial representations” include, but are not limited to, logos, graphics, trademarks, or other symbols associated with companies, individuals, corporations, or any other entities as discussed herein, and/or as known in the art at the time of filing, and/or as developed after the time of filing.

In one embodiment, the source document data is analyzed at ANALYZE THE SOURCE DOCUMENT DATA TO IDENTIFY POTENTIAL PICTORIAL REPRESENTATION DATA OPERATION 209 to identify potential pictorial representations by first identifying non-text data and any identified non-text data is designated as potential pictorial representation data.

In one embodiment, the potential pictorial representation data is then analyzed at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 and key data associated with the potential pictorial representation data is generated.

In one embodiment, potential pictorial representations are identified at ANALYZE THE SOURCE DOCUMENT DATA TO IDENTIFY POTENTIAL PICTORIAL REPRESENTATION DATA OPERATION 209 by first obtaining the source document data of OBTAIN SOURCE DOCUMENT DATA OPERATION 207 in the form of digital image data representing the source document, e.g., a digital image of the source document.

As discussed above, in various embodiments, the digital image data representation of the source document is obtained at OBTAIN SOURCE DOCUMENT DATA OPERATION 207 using a digital image capture capability associated with a computing system, such as a camera capability included with a smart phone accessible by the user.

In one embodiment, at ANALYZE THE SOURCE DOCUMENT DATA TO IDENTIFY POTENTIAL PICTORIAL REPRESENTATION DATA OPERATION 209 digital image data representing the source document is sent to an Optical Character Recognition (OCR) capability, such as any OCR engine, for text extraction. In one embodiment, the OCR capability returns a collection of text data along with the associated location within the source document.

In one embodiment, the entire digital image of the source document of OBTAIN SOURCE DOCUMENT DATA OPERATION 207 is scanned at ANALYZE THE SOURCE DOCUMENT DATA TO IDENTIFY POTENTIAL PICTORIAL REPRESENTATION DATA OPERATION 209, in one embodiment, starting from the top left of the document, to detect the luminosity of each pixel by scanning through the digital image data representing the source document row by row.

In one embodiment, at ANALYZE THE SOURCE DOCUMENT DATA TO IDENTIFY POTENTIAL PICTORIAL REPRESENTATION DATA OPERATION 209 all regions determined by the OCR engine to contain textual data are avoided.

In one embodiment, at ANALYZE THE SOURCE DOCUMENT DATA TO IDENTIFY POTENTIAL PICTORIAL REPRESENTATION DATA OPERATION 209 luminosity for each pixel is obtained by applying weights to Red (R), Green (G) and Blue (B) channels to generate greyscale pixels.

In one embodiment, the greyscale strength so determined at ANALYZE THE SOURCE DOCUMENT DATA TO IDENTIFY POTENTIAL PICTORIAL REPRESENTATION DATA OPERATION 209 is designated the luminosity of the pixel.

In one embodiment, when a threshold change in luminosity is encountered when scanning from one pixel to adjacent pixels at ANALYZE THE SOURCE DOCUMENT DATA TO IDENTIFY POTENTIAL PICTORIAL REPRESENTATION DATA OPERATION 209, this change is determined to indicate the start of a potential pictorial representation, i.e., a graphic or logo in the digital image of the source document. In one embodiment, at ANALYZE THE SOURCE DOCUMENT DATA TO IDENTIFY POTENTIAL PICTORIAL REPRESENTATION DATA OPERATION 209 this location is marked and scanning continues until the luminosity again changes more than the threshold value. Once this change back is detected, this change is determined to indicate the end of the potential pictorial representation.

This process is repeated at ANALYZE THE SOURCE DOCUMENT DATA TO IDENTIFY POTENTIAL PICTORIAL REPRESENTATION DATA OPERATION 209 to detect the entire potential pictorial representation region, e.g., bounding box rectangle, or other shape, of the potential pictorial representation.

In one embodiment, once the source document data of OBTAIN SOURCE DOCUMENT DATA OPERATION 207 is analyzed to identify potential pictorial representations within the source document data at ANALYZE THE SOURCE DOCUMENT DATA TO IDENTIFY POTENTIAL PICTORIAL REPRESENTATION DATA OPERATION 209, process flow proceeds to ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211.

In one embodiment, at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 the identified potential pictorial representation region of ANALYZE THE SOURCE DOCUMENT DATA TO IDENTIFY POTENTIAL PICTORIAL REPRESENTATION DATA OPERATION 209 is extracted from the digital image of the source document data of OBTAIN SOURCE DOCUMENT DATA OPERATION 207 and key data is generated for the identified potential pictorial representation region.

In one embodiment, at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 the identified potential pictorial representation region of ANALYZE THE SOURCE DOCUMENT DATA TO IDENTIFY POTENTIAL PICTORIAL REPRESENTATION DATA OPERATION 209 is extracted from the digital image of the source document data of OBTAIN SOURCE DOCUMENT DATA OPERATION 207 and the data is sent to the same hashing process used to create the hash associated with each of the one or more known pictorial representations in the template database at GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205.

In one embodiment, at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 the hash value for the potential pictorial representation is then designated as the key data associated with the potential pictorial representation.

In one embodiment, once the identified potential pictorial representation region of ANALYZE THE SOURCE DOCUMENT DATA TO IDENTIFY POTENTIAL PICTORIAL REPRESENTATION DATA OPERATION 209 is extracted from the digital image of the source document data of OBTAIN SOURCE DOCUMENT DATA OPERATION 207 and key data is generated for the identified potential pictorial representation region at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211, process flow proceeds to COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213.

In one embodiment, at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213, the key data of ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 associated with the potential pictorial representation of ANALYZE THE SOURCE DOCUMENT DATA TO IDENTIFY POTENTIAL PICTORIAL REPRESENTATION DATA OPERATION 209 is analyzed and compared with the key data associated with the known pictorial representations of GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 in the template database for known source documents sources of CREATE A TEMPLATE DATABASE INCLUDING ONE OR MORE DATA EXTRACTION TEMPLATES OPERATION 203.

In one embodiment, once the key data of ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 associated with the potential pictorial representation of ANALYZE THE SOURCE DOCUMENT DATA TO IDENTIFY POTENTIAL PICTORIAL REPRESENTATION DATA OPERATION 209 is analyzed and compared with the key data associated with the known pictorial representations of GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 in the template database for known source documents sources of CREATE A TEMPLATE DATABASE INCLUDING ONE OR MORE DATA EXTRACTION TEMPLATES OPERATION 203 at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213, process flow proceeds to MATCH THE KEY DATA ASSOCIATED WITH THE POTENTIAL PICTORIAL REPRESENTATION DATA WITH THE KEY DATA ASSOCIATED WITH A MATCHED ONE OF THE KNOWN PICTORIAL REPRESENTATIONS OPERATION 215.

In one embodiment, at MATCH THE KEY DATA ASSOCIATED WITH THE POTENTIAL PICTORIAL REPRESENTATION DATA WITH THE KEY DATA ASSOCIATED WITH A MATCHED ONE OF THE KNOWN PICTORIAL REPRESENTATIONS OPERATION 215 the key data associated with the potential pictorial representation of ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 is determined at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213 to match the key data associated with at least one of the known pictorial representations in the template database of GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205.

In one embodiment, once the key data associated with the potential pictorial representation of ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 is determined at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213 to match the key data associated with at least one of the known pictorial representations in the template database of GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 at MATCH THE KEY DATA ASSOCIATED WITH THE POTENTIAL PICTORIAL REPRESENTATION DATA WITH THE KEY DATA ASSOCIATED WITH A MATCHED ONE OF THE KNOWN PICTORIAL REPRESENTATIONS OPERATION 215, process flow proceeds to USE A DATA EXTRACTION TEMPLATE ASSOCIATED WITH THE MATCHED ONE OF THE KNOWN PICTORIAL REPRESENTATIONS FOR IDENTIFYING AND EXTRACTING DATA FROM THE SOURCE DOCUMENT DATA OPERATION 217.

In one embodiment, at USE A DATA EXTRACTION TEMPLATE ASSOCIATED WITH THE MATCHED ONE OF THE KNOWN PICTORIAL REPRESENTATIONS FOR IDENTIFYING AND EXTRACTING DATA FROM THE SOURCE DOCUMENT DATA OPERATION 217 the data extraction template of CREATE A TEMPLATE DATABASE INCLUDING ONE OR MORE DATA EXTRACTION TEMPLATES OPERATION 203 for the source document source associated with the matched key data associated with at least one of the known pictorial representations in the template database is obtained and used to identify and extract the desired source data from the source document data.

As a specific illustrative example of the operation of one embodiment of process 200, assume at OBTAIN SOURCE DOCUMENT DATA OPERATION 207 a user takes a picture of a paper bill including the bill payee's logo using mobile device camera.

The digital image of the paper bill is then scanned at ANALYZE THE SOURCE DOCUMENT DATA TO IDENTIFY POTENTIAL PICTORIAL REPRESENTATION DATA OPERATION 209 to detect the logo/letterhead associated with the provider of the bill. The logo/letterhead data is then processed as discussed above to generate key data for the logo/letterhead at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211.

In this specific illustrative example, the key data associated with the logo/letterhead is then analyzed at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213 and at MATCH THE KEY DATA ASSOCIATED WITH THE POTENTIAL PICTORIAL REPRESENTATION DATA WITH THE KEY DATA ASSOCIATED WITH A MATCHED ONE OF THE KNOWN PICTORIAL REPRESENTATIONS OPERATION 215 is matched with key data associated with a known pictorial representation in the template database of CREATE A TEMPLATE DATABASE INCLUDING ONE OR MORE DATA EXTRACTION TEMPLATES OPERATION 203. Consequently at USE A DATA EXTRACTION TEMPLATE ASSOCIATED WITH THE MATCHED ONE OF THE KNOWN PICTORIAL REPRESENTATIONS FOR IDENTIFYING AND EXTRACTING DATA FROM THE SOURCE DOCUMENT DATA OPERATION 217 the correct data extraction template in the template database of CREATE A TEMPLATE DATABASE INCLUDING ONE OR MORE DATA EXTRACTION TEMPLATES OPERATION 203 is accessed and used on the current source document data of OBTAIN SOURCE DOCUMENT DATA OPERATION 207. The correct data extraction template can then be used to accurately extract relevant information/data, such as, but not limited to, payee name, address, account number, due date, amount due, etc.

As another specific illustrative example, assume a user opens a paper bill from a small business. The user intends to perform an electronic bill payment. In this example, the user captures an image of the bill at OBTAIN SOURCE DOCUMENT DATA OPERATION 207 using an image capture device associated with the user's cell phone.

Then at ANALYZE THE SOURCE DOCUMENT DATA TO IDENTIFY POTENTIAL PICTORIAL REPRESENTATION DATA OPERATION 209 OCR technology is used to scan the entire image of the bill and any the portion of the image of the bill that is detected to contain non-text data is designated a potential pictorial representation area.

At ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 these potential pictorial representation areas are then cropped and resized and a hash value or unique signature is calculated for the potential pictorial representation areas, which is used as key data for the potential pictorial representation areas.

At COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213 the key data for a potential pictorial representation area is then analyzed and compared with key data of GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 associated with known pictorial representations in the template database of CREATE A TEMPLATE DATABASE INCLUDING ONE OR MORE DATA EXTRACTION TEMPLATES OPERATION 203.

If a match is found at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213 and MATCH THE KEY DATA ASSOCIATED WITH THE POTENTIAL PICTORIAL REPRESENTATION DATA WITH THE KEY DATA ASSOCIATED WITH A MATCHED ONE OF THE KNOWN PICTORIAL REPRESENTATIONS OPERATION 215 relevant information in the source document, i.e., the bill, such as payee name, address, account number is extracted at USE A DATA EXTRACTION TEMPLATE ASSOCIATED WITH THE MATCHED ONE OF THE KNOWN PICTORIAL REPRESENTATIONS FOR IDENTIFYING AND EXTRACTING DATA FROM THE SOURCE DOCUMENT DATA OPERATION 217 using the data extraction template associated with the matched pictorial representations in the template database.

The extracted data is then presented to the user for review. If the extracted information/data is correct, the user can accept the extracted data and complete bill payment.

In one embodiment, if no match is found at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213, the user is presented with an option to create a data extraction template and this data extraction template, along with the key data associated with potential pictorial representations in the bill, is added to the pictorial representations data in the template database for future users.

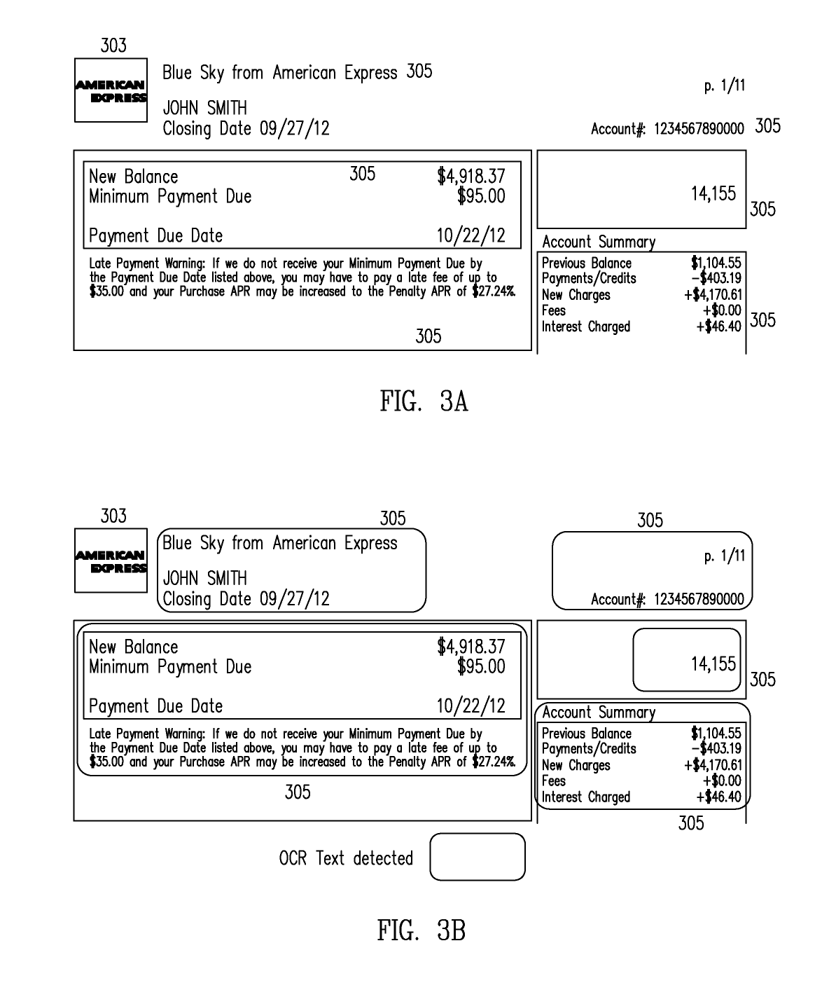

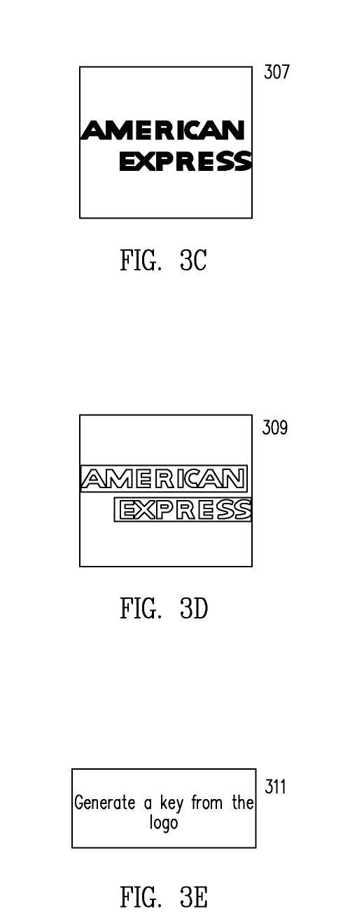

FIGS. 3A to 3E show some of the steps in another specific example of one implementation of one embodiment of process 200 for data identification and extraction using pictorial representations in a source document.

FIG. 3A shows an optical image of a source document 300. In one embodiment, at OBTAIN SOURCE DOCUMENT DATA OPERATION 207 a user takes a picture of the source document, for sake of simplicity just the top portion of the source document is shown in FIG. 3A with text regions 301 and pictorial representation region 303.

As seen in FIG. 3B, in one embodiment, at ANALYZE THE SOURCE DOCUMENT DATA TO IDENTIFY POTENTIAL PICTORIAL REPRESENTATION DATA OPERATION 209 OCR processing is performed on optical image of the source document 300 of FIG. 3A to generate OCR processed blocks 305. It is worth noting that OCR processed blocks 305 do not include pictorial representation region 303.

As seen in FIG. 3C at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 pictorial representation region 303 is extracted from optical image of a source document 300 to and, in one embodiment, is resized to a standard size, as an illustrative example, 100×100 pixels, to generate potential pictorial representation region 307.

As seen in FIG. 3D, in one embodiment, at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 chroma key filtering is applied to the extracted potential pictorial representation region 307 to remove any background noise and potential pictorial representation region 307 is converted to gray-scale image 309.

In one embodiment, at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 edge detection algorithms such as Canny-Edge or Hariss Corner may be applied to highlight the text in gray-scale image 309.

As seen in FIG. 3E, in one embodiment, at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 the hash value of gray-scale image 309 is calculated as a sequence of 0's and l's (e.g.: −11100101). In various embodiment, any standard algorithm MD5, MD4 or SHA can be used in calculating this value.

In one embodiment, at ANALYZE THE POTENTIAL PICTORIAL REPRESENTATION DATA AND GENERATE KEY DATA ASSOCIATED WITH THE POTENTIAL PICTORIAL REPRESENTATION DATA OPERATION 211 the calculated hash value is then used as potential pictorial representation key data 311.

In one embodiment, at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213 this potential pictorial representation key data 311 is analyzed and compared to the known pictorial representations of GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 in the template database of CREATE A TEMPLATE DATABASE INCLUDING ONE OR MORE DATA EXTRACTION TEMPLATES OPERATION 203 and a match is identified at MATCH THE KEY DATA ASSOCIATED WITH THE POTENTIAL PICTORIAL REPRESENTATION DATA WITH THE KEY DATA ASSOCIATED WITH A MATCHED ONE OF THE KNOWN PICTORIAL REPRESENTATIONS OPERATION 215.

In one embodiment, at USE A DATA EXTRACTION TEMPLATE ASSOCIATED WITH THE MATCHED ONE OF THE KNOWN PICTORIAL REPRESENTATIONS FOR IDENTIFYING AND EXTRACTING DATA FROM THE SOURCE DOCUMENT DATA OPERATION 217 the correct data extraction template is obtained and used to extract the desired data.

In some embodiments, the extracted potential pictorial representation data itself, i.e., the unprocessed potential pictorial representation region data 307 is stored as the potential pictorial representation key data 311 and at COMPARE THE KEY DATA ASSOCIATED WITH THE POTENTIAL PICTORIAL REPRESENTATION DATA WITH THE KEY DATA ASSOCIATED WITH ONE OR MORE KNOWN PICTORIAL REPRESENTATIONS OPERATION 213 this potential pictorial representation key data is analyzed and compared to the known pictorial representations of GENERATE PICTORIAL REPRESENTATION DATA INCLUDING KEY DATA ASSOCIATED WITH ONE OR MORE KNOWN PICTORIAL REPRESENTATIONS ASSOCIATED WITH ONE OR MORE SOURCE DOCUMENT SOURCES OPERATION 205 in the template database of CREATE A TEMPLATE DATABASE INCLUDING ONE OR MORE DATA EXTRACTION TEMPLATES OPERATION 203 and a match is identified at MATCH THE KEY DATA ASSOCIATED WITH THE POTENTIAL PICTORIAL REPRESENTATION DATA WITH THE KEY DATA ASSOCIATED WITH A MATCHED ONE OF THE KNOWN PICTORIAL REPRESENTATIONS OPERATION 215.

In one embodiment, once the data extraction template of CREATE A TEMPLATE DATABASE INCLUDING ONE OR MORE DATA EXTRACTION TEMPLATES OPERATION 203 for the source document source associated with the matched key data associated with at least one of the known pictorial representations in the template database is obtained and used to identify and extract the desired source data from the source document data at USE A DATA EXTRACTION TEMPLATE ASSOCIATED WITH THE MATCHED ONE OF THE KNOWN PICTORIAL REPRESENTATIONS FOR IDENTIFYING AND EXTRACTING DATA FROM THE SOURCE DOCUMENT DATA OPERATION 217, process flow proceeds to EXIT OPERATION 230.

In one embodiment, at EXIT OPERATION 230, process 200 for data identification and extraction using pictorial representations in a source document is exited to await new data.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

Using the process 200 for data identification and extraction using pictorial representations in a source document discussed herein, pictorial representations, such as logos, present in a source document are used to identify the organization, corporation, person, party, or other entity associated with the pictorial representation, i.e., the source of the source document, and to obtain the correct data extraction template associated with that source document. In this way, data can be extracted from various source documents despite the fact that various source documents from different sources and will include different formatting and different placement of data fields and data.

Consequently, using process 200 for data identification and extraction using pictorial representations in a source document, the extraction and transfer of data from source documents to various data management systems is made more efficient, accurate, and user-friendly.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for data identification and extraction using pictorial representations in a source document comprising the following, which when executed individually or collectively by any set of one or more processors perform a process including:
creating a template database, the template database including one or more data extraction templates for identifying and extracting data from one or more source documents, each data extraction template being associated with source documents from a specific source document source;
generate pictorial representation data, the pictorial representation data including key data associated with one or more known pictorial representations, the one or more known pictorial representations each being associated with one or more source document sources;
obtaining source document data;
analyzing the source document data to identify potential pictorial representation data;
analyzing the potential pictorial representation data and generating key data associated with the potential pictorial representation data;
comparing the key data associated with the potential pictorial representation data with the key data associated with one or more known pictorial representations; and
if the key data associated with the potential pictorial representation data matches the key data associated with a matched one of the known pictorial representations, using the data extraction template associated with the matched one of the pictorial representations in the pictorial representation database for identifying and extracting data from the source document data.

2. The computing system implemented method for data identification and extraction using pictorial representations in a source document of claim 1 wherein the source document data is obtained from a printed source document using a digital image capture device.

3. The computing system implemented method for data identification and extraction using pictorial representations in a source document of claim 2 wherein the source document data is obtained from a printed source document using a digital image capture device implemented on a mobile computing system.

4. The computing system implemented method for data identification and extraction using pictorial representations in a source document of claim 1 wherein the source document data is obtained from an electronic copy of the source document.

5. The computing system implemented method for data identification and extraction using pictorial representations in a source document of claim 1 wherein the pictorial representations are logos associated with source document sources.

6. The computing system implemented method for data identification and extraction using pictorial representations in a source document of claim 1 wherein the potential pictorial representation data is identified by a process comprising:
processing the source document data using an Optical Character Recognition (OCR) system and identifying all regions containing textual data;
for all regions not determined by the OCR system to contain textual data, determining the luminosity of each pixel in the non-textual regions of source document data by applying weights to Red (R), Green (G), and Blue (B) channels to transform the pixel into a greyscale pixel and designating the greyscale strength the luminosity of the pixel;
defining a threshold change in luminosity value such that a change in luminosity value greater than the threshold change in luminosity is identified as the start or end of an non-textual region of source document including a pictorial representation;
detecting a first change in luminosity value greater than the threshold change in luminosity and designating the area of the first change in luminosity value as the start of a non-textual region of source document including a pictorial representation;
looping over the non-textual region of source document until a second change in luminosity value greater than the threshold change is detected;
designating the area of the second change in luminosity value as the end of the non-textual region of source document including a pictorial representation; and
designating the non-textual region of source document including a pictorial representation as potential pictorial representation data.

7. The computing system implemented method for data identification and extraction using pictorial representations in a source document of claim 1 wherein the key data associated with the known pictorial representations or potential pictorial representations is generated by analyzing the known pictorial representations or potential pictorial representations and determining a unique hash value for the known pictorial representations or potential pictorial representations.

8. A system for data identification and extraction using pictorial representations in a source document comprising:
at least one processor; and
at least one memory coupled to the at least one processor, the at least one memory having stored therein instructions which when executed by any set of the one or more processors, perform a process for data identification and extraction using pictorial representations in a source document, the process for data identification and extraction using pictorial representations in a source document including:
creating a template database, the template database including one or more data extraction templates for identifying and extracting data from one or more source documents, each data extraction template being associated with source documents from a specific source document source;
generate pictorial representation data, the pictorial representation data including key data associated with one or more known pictorial representations, the one or more known pictorial representations each being associated with one or more source document sources;
obtaining source document data;
analyzing the source document data to identify potential pictorial representation data;
analyzing the potential pictorial representation data and generating key data associated with the potential pictorial representation data;
comparing the key data associated with the potential pictorial representation data with the key data associated with one or more known pictorial representations; and
if the key data associated with the potential pictorial representation data matches the key data associated with a matched one of the known pictorial representations, using the data extraction template associated with the matched one of the pictorial representations in the pictorial representation database for identifying and extracting data from the source document data.

9. The system for data identification and extraction using pictorial representations in a source document of claim 8 wherein the source document data is obtained from a printed source document using a digital image capture device.

10. The system for data identification and extraction using pictorial representations in a source document of claim 9 wherein the source document data is obtained from a printed source document using a digital image capture device implemented on a mobile computing system.

11. The system for data identification and extraction using pictorial representations in a source document of claim 8 wherein the source document data is obtained from an electronic copy of the source document.

12. The system for data identification and extraction using pictorial representations in a source document of claim 8 wherein the pictorial representations are logos associated with source document sources.

13. The system for data identification and extraction using pictorial representations in a source document of claim 8 wherein the potential pictorial representation data is identified by a process comprising:
processing the source document data using an Optical Character Recognition (OCR) system and identifying all regions containing textual data;
for all regions not determined by the OCR system to contain textual data, determining the luminosity of each pixel in the non-textual regions of source document data by applying weights to Red (R), Green (G), and Blue (B) channels to transform the pixel into a greyscale pixel and designating the greyscale strength the luminosity of the pixel;
defining a threshold change in luminosity value such that a change in luminosity value greater than the threshold change in luminosity is identified as the start or end of an non-textual region of source document including a pictorial representation;
detecting a first change in luminosity value greater than the threshold change in luminosity and designating the area of the first change in luminosity value as the start of a non-textual region of source document including a pictorial representation;
looping over the non-textual region of source document until a second change in luminosity value greater than the threshold change is detected;
designating the area of the second change in luminosity value as the end of the non-textual region of source document including a pictorial representation; and
designating the non-textual region of source document including a pictorial representation as potential pictorial representation data.

14. The system for data identification and extraction using pictorial representations in a source document of claim 8 wherein the key data associated with the known pictorial representations or potential pictorial representations is generated by analyzing the known pictorial representations or potential pictorial representations and determining a unique hash value for the known pictorial representations or potential pictorial representations.

15. A system for data identification and extraction using pictorial representations in a source document comprising:
a template database, the template database including one or more data extraction templates for identifying and extracting data from one or more source documents, each data extraction template being associated with source documents from a specific source document source;
a pictorial representation database, the pictorial representation database including key data associated with one or more known pictorial representations, the one or more known pictorial representations each being associated with one or more source document sources;
source document data;
at least one processor; and
at least one memory coupled to the at least one processor, the at least one memory having stored therein instructions which when executed by any set of the one or more processors, perform a process for data identification and extraction using pictorial representations in a source document, the process for data identification and extraction using pictorial representations in a source document including:
analyzing the source document data to identify potential pictorial representation data;
analyzing the potential pictorial representation data and generating key data associated with the potential pictorial representation data;
comparing the key data associated with the potential pictorial representation data with the key data associated with one or more known pictorial representations in the pictorial representation database; and
if the key data associated with the potential pictorial representation data matches the key data associated with a matched one of the known pictorial representations in the pictorial representation database, using the data extraction template associated with the matched one of the known pictorial representations in the pictorial representation database for identifying and extracting data from the source document data.

16. The system for data identification and extraction using pictorial representations in a source document of claim 15 wherein the source document data is obtained from a printed source document using a digital image capture device.

17. The system for data identification and extraction using pictorial representations in a source document of claim 16 wherein the source document data is obtained from a printed source document using a digital image capture device implemented on a mobile computing system.

18. The system for data identification and extraction using pictorial representations in a source document of claim 15 wherein the source document data is obtained from an electronic copy of the source document.

19. The system for data identification and extraction using pictorial representations in a source document of claim 15 wherein the pictorial representations are logos associated with source document sources.

20. The system for data identification and extraction using pictorial representations in a source document of claim 15 wherein the potential pictorial representation data is identified by a process comprising:
processing the source document data using an Optical Character Recognition (OCR) system and identifying all regions containing textual data;
for all regions not determined by the OCR system to contain textual data, determining the luminosity of each pixel in the non-textual regions of source document data by applying weights to Red (R), Green (G), and Blue (B) channels to transform the pixel into a greyscale pixel and designating the greyscale strength the luminosity of the pixel;
defining a threshold change in luminosity value such that a change in luminosity value greater than the threshold change in luminosity is identified as the start or end of an non-textual region of source document including a pictorial representation;
detecting a first change in luminosity value greater than the threshold change in luminosity and designating the area of the first change in luminosity value as the start of a non-textual region of source document including a pictorial representation;
looping over the non-textual region of source document until a second change in luminosity value greater than the threshold change is detected;
designating the area of the second change in luminosity value as the end of the non-textual region of source document including a pictorial representation; and
designating the non-textual region of source document including a pictorial representation as potential pictorial representation data.

21. The system for data identification and extraction using pictorial representations in a source document of claim 15 wherein the key data associated with the known pictorial representations or potential pictorial representations is generated by analyzing the known pictorial representations or potential pictorial representations and determining a unique hash value for the known pictorial representations or potential pictorial representations.

22. A computing system implemented method for identifying potential pictorial representation data in a source document comprising the following, which when executed individually or collectively by any set of one or more processors perform a process including:
processing source document data using an Optical Character Recognition (OCR) system and identifying all regions containing textual data;
for all regions not determined by the OCR system to contain textual data, determining the luminosity of each pixel in the non-textual regions of source document data by applying weights to Red (R), Green (G), and Blue (B) channels to transform the pixel into a greyscale pixel and designating the greyscale strength the luminosity of the pixel;
defining a threshold change in luminosity value such that a change in luminosity value greater than the threshold change in luminosity is identified as the start or end of an non-textual region of source document including a pictorial representation;
detecting a first change in luminosity value greater than the threshold change in luminosity and designating the area of the first change in luminosity value as the start of a non-textual region of source document including a pictorial representation;
looping over the non-textual region of source document until a second change in luminosity value greater than the threshold change is detected;
designating the area of the second change in luminosity value as the end of the non-textual region of source document including a pictorial representation; and
designating the non-textual region of source document including a pictorial representation as potential pictorial representation data.

23. A system for identifying potential pictorial representation data in a source document comprising:
at least one processor; and
at least one memory coupled to the at least one processor, the at least one memory having stored therein instructions which when executed by any set of the one or more processors, perform a process for data identification and extraction using pictorial representations in a source document, the process for data identification and extraction using pictorial representations in a source document including:
processing source document data using an Optical Character Recognition (OCR) system and identifying all regions containing textual data;
for all regions not determined by the OCR system to contain textual data, determining the luminosity of each pixel in the non-textual regions of source document data by applying weights to Red (R), Green (G), and Blue (B) channels to transform the pixel into a greyscale pixel and designating the greyscale strength the luminosity of the pixel;
defining a threshold change in luminosity value such that a change in luminosity value greater than the threshold change in luminosity is identified as the start or end of an non-textual region of source document including a pictorial representation;
detecting a first change in luminosity value greater than the threshold change in luminosity and designating the area of the first change in luminosity value as the start of a non-textual region of source document including a pictorial representation;
looping over the non-textual region of source document until a second change in luminosity value greater than the threshold change is detected;
designating the area of the second change in luminosity value as the end of the non-textual region of source document including a pictorial representation; and
designating the non-textual region of source document including a pictorial representation as potential pictorial representation data.
